(19) United States
(12) Patent Application Publication
(10) Pub. No.: US 2014/0023115 A1
(43) Pub. Date: Jan. 23, 2014

(54) FUEL PROPERTY SENSOR

(71) Applicant: Denso Corporation, Kariya-city (JP)

(72) Inventors: Masato UENO, Takahama-city (JP); Hiroshi NAKAMURA, Nishio-city (JP); Tatsuya KITANAKA, Nagoya-city (JP); Dai OSADA, Kariya-city (JP)

(21) Appl. No.: 13/932,122

(22) Filed: Jul. 1, 2013

(30) Foreign Application Priority Data
Jul. 19, 2012 (JP) 2012-160607

(51) Int. Cl. G01K 7/22

(52) U.S. Cl. CPC G01K 7/22
USPC 374/183

(57) ABSTRACT

A fuel property sensor includes an external electrode, an internal electrode, a temperature detecting device, a holder portion, a sealing portion. The external electrode includes a passage portion and a projecting portion to define a transfer passage through which fuel flows. The internal electrode is disposed in the passage portion of the external electrode. The temperature detecting device detects a fuel temperature. The holder portion holds the temperature detecting device. The holder portion has a bottomed-cylindrical shape and disposed in the transfer passage and the through-hole of the internal electrode, or the holder portion has a cylindrical shape and disposed in the transfer passage. The sealing portion seals the transfer passage and prevents fuel flowing in the transfer passage from leaking outside.

### CROSS REFERENCE TO RELATED APPLICATION

This application is based on Japanese Patent Application No. 2012-160607 filed on Jul. 19, 2012, the disclosure of which is incorporated herein by reference in its entirety.

### TECHNICAL FIELD

The present disclosure relates to a fuel property sensor that determines an alcohol concentration of fuel.

### BACKGROUND

Conventionally, a fuel property sensor detects an alcohol concentration of fuel. Specifically, the fuel property sensor calculates capacitance between two electrodes based on a charge quantity of the two electrodes soaked in the fuel, and the alcohol concentration is calculated based on a relationship between the capacitance and a detected fuel temperature. For instance, JP-A-2009-505074 (U.S. Pat. No. 7,466,147) describes such a fuel property sensor in which a thermistor is disposed in an attachment portion that abuts to a second electrode soaked in fuel, and a fluid quality sensor that detects fuel temperature is employed.

However, in the fluid quality sensor of JP-A-2009-505074, a temperature detecting position of the thermistor is positioned to face a first electrode, and an outer wall of the first electrode is exposed to the outside. By having such a structure, heat transfers easily from the external environment via the first electrode and may have a large effect on a temperature detected by the thermistor.

Therefore, a detection error of the fuel temperature detected by the thermistor may be increased.

It is an objective of the present disclosure to provide a fuel property sensor which can effectively reduce detection error.

### SUMMARY

According to an example of the present disclosure, there is provided a fuel property sensor having an external electrode, an internal electrode, a temperature detecting device, a holder portion, a sealing portion, and a calculation unit. The external electrode includes a passage portion, which defines a fuel passage, and a projecting portion. The passage portion and the projecting portion define a transfer passage, in which fuel flows therethrough, and the projecting portion radially projects from the passage portion. The internal electrode is disposed in the passage portion of the external electrode at a predetermined distance from an inner wall of the passage portion. The internal electrode defines a through-hole. The temperature detecting device detects a fuel temperature. The holder portion has a cylinder portion and a bottom portion, which define a bottomed-cylindrical holding space, in which the temperature detecting device is disposed. The sealing portion is disposed between an outer wall of the holder portion and an inner wall of the transfer passage. The sealing portion insulates the external electrode and the holder portion from each other, and prevents fuel flowing in the transfer passage from leaking outside. The calculation unit calculates fuel properties based on the fuel temperature detected by the temperature detecting device and calculating electrical characteristics of fuel flowing between the external electrode and the internal electrode.

According to an example of the present disclosure, there is provided a fuel property sensor having an external electrode, an internal electrode, a temperature detecting device, a holder portion, a sealing portion, and a calculation unit. The external electrode includes a passage portion, which defines a fuel passage, and a projecting portion. The passage portion and the projecting portion define a transfer passage, in which fuel flows therethrough, and the projecting portion radially projects from the passage portion. The internal electrode is disposed in the passage portion of the external electrode at a predetermined distance from the inner wall of the passage portion. The temperature detecting device detects a fuel temperature. The holder portion has a cylindrical shape with an opening provided at both ends, and the temperature detecting device is disposed therein. The sealing portion is disposed between an outer wall of the holder portion and an inner wall of the transfer passage. The sealing portion insulates the external electrode and the holder portion from each other, and prevents fuel flowing in the transfer passage from leaking outside. The calculation unit calculates fuel properties based on the fuel temperature detected by the temperature detecting device and calculates electrical characteristics of fuel flowing between the external electrode and the internal electrode.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of a fuel supply system that employs a fuel property sensor according to a first embodiment;

FIG. 2 is a cross-sectional view of the fuel property sensor according to the first embodiment;

FIG. 3 is a schematic cross-sectional view taken along a line of FIG. 2 according to the first embodiment;

FIG. 4 is a cross-sectional view of a fuel property sensor according to a second embodiment; and

FIG. 5 is a schematic cross-sectional view taken along a line V-V of FIG. 4 according to the second embodiment.

### DETAILED DESCRIPTION

Embodiments of the present disclosure will now be described hereafter with reference to drawings. In the embodiments, a part that corresponds to a matter described in a preceding embodiment may be assigned with the same reference numeral, and redundant explanation for the part may be omitted.

When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

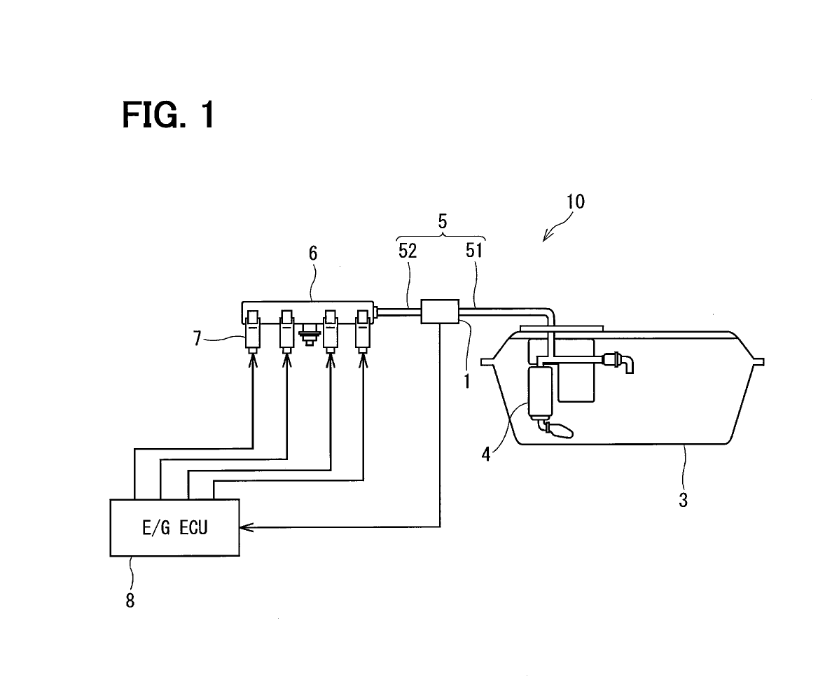

A first embodiment will be described with reference to FIGS. 1-3.

As shown in FIG. 1, a fuel supply system 10 that supplies the fuel to an internal combustion engine (not shown) has a fuel property sensor 1. The fuel property sensor 1 is disposed at a fuel pipe 5 that connects a fuel tank 3 and a delivery pipe 6. The fuel tank 3 stores fuel in which gasoline and ethanol are mixed. Gasoline, ethanol, or a mixture of gasoline and ethanol may be supplied to the fuel tank 3 as needed. Therefore, when gasoline, ethanol, or the mixture of gasoline and ethanol is supplied to the fuel tank 3, an ethanol concentration of the fuel stored in the fuel tank 3 may change.

A fuel pump 4 pumps fuel stored in the fuel tank 3 to the delivery pipe 6 via the fuel pipe 5, and an injector 7 sprays the fuel into an intake pipe of a cylinder. An engine control unit (E/G ECU) 8, which is a unit that controls an internal combustion engine, electrically controls actuation of the injector 7.

The ECU 8 includes a micro computer and the like. The fuel property sensor 1 transmits a signal to the ECU 8. Based on an ethanol concentration detected by the fuel property sensor 1, the ECU 8 controls various controlled parameters such as an air-fuel ratio, an amount of fuel consumption, and ignition timing. To actuate the internal combustion engine under optimum conditions, the fuel property sensor 1 may be disposed as close to the injector 7 as possible.

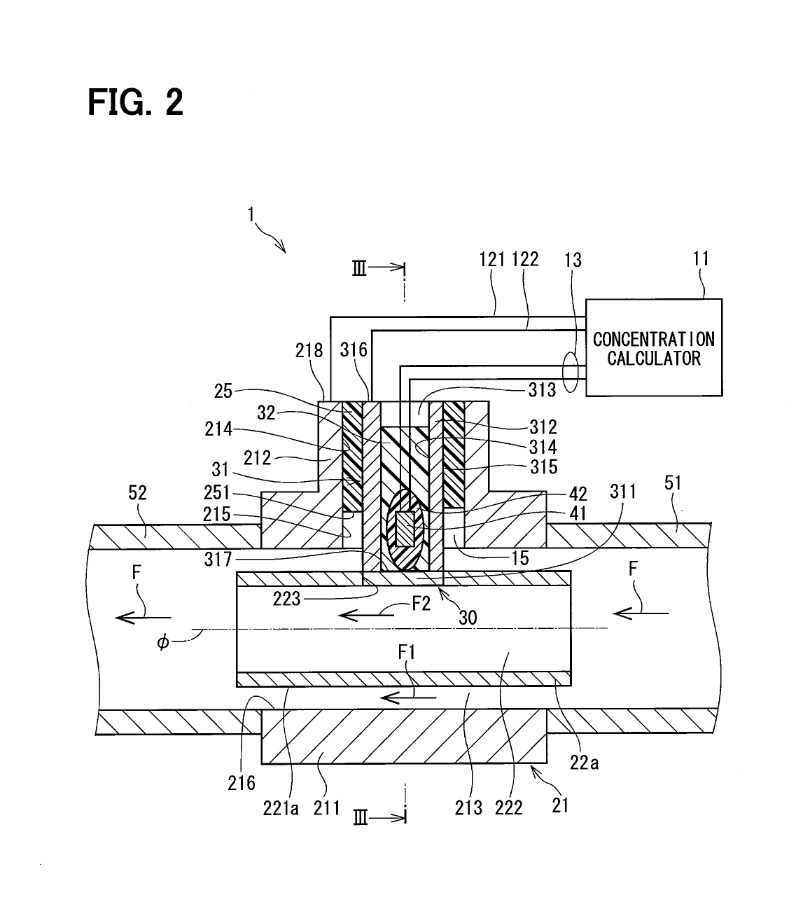

As shown in FIG. 2, the fuel property sensor 1 has an external electrode 21, an internal electrode 22a, a temperature detecting part 30, and a concentration calculator 11 (i.e., a calculation unit). In FIG. 2, arrows F, F1 and F2 show the direction in which the fuel flows.

The external electrode 21 is a metallic member having a passage portion 211 and a cylinder portion 212 (i.e., a projecting portion), which are integrated to form the external electrode 21. The passage portion 211 has an opening at both of its ends, and the cylinder potion 212 extends generally perpendicular to the passage portion 211.

The passage portion 211 is a cylindrical metallic member. The fuel pipe 5 includes a first pipe 51 and a second pipe 52. The passage portion 211 is disposed so that its central axis is in parallel with a fuel flow direction in the first pipe 51 and the second pipe 52 (i.e., parallel with F). A first opening at a first end of the passage portion 211 and the first pipe 51 are connected to transmit fuel. A second opening at a second end of the passage portion 211 and the second pipe 52 are connected to transmit fuel. The passage portion 211 defines a fuel passage 213. When fuel flows from the fuel tank 3 to the delivery pipe 6, a part of the fuel passes through the fuel passage 213 as shown by the arrow F1 in FIG. 2.

The cylinder portion 212 extends in a radial-outward direction of the passage portion 211. An end part 218 of the cylinder portion 212 is an end of the cylinder portion 212 that is farther from the central axis than the other end of the cylinder portion 212, and a conductive wire 121 is coupled to the end part 218. The conductive wire 121 is also coupled to the concentration calculator 11.

The external electrode 21 has a transfer passage 214 that is arranged to penetrate the passage portion 211 to link the fuel passage 213 to the outside of the external electrode 21 via the transfer passage 214. The transfer passage 214 is disposed to be perpendicular to the central axis . A temperature detecting part holder 31 (i.e., a first holder portion), which holds the temperature detecting part 30, is disposed in the transfer passage 214.

The temperature detecting part 30 includes a thermistor 41 (i.e., temperature detecting device) and the temperature detecting part holder 31 holds the thermistor 41 by holding the temperature detecting part 30.

The internal electrode 22a is a cylindrical metallic member that is located at the medial of the passage portion 211. The internal electrode 22a is positioned to have a predetermined distance between an outer wall 221a of the internal electrode 22a and an inner wall 216 of the passage portion 211. A central axis of the internal electrode 22a is coaxial with the central axis . The outer wall 221a of the internal electrode 22a defines a through-hole 223, and the temperature detecting part 30 is disposed in the through-hole 223. The internal electrode 22a defines a fuel passage 222. When fuel flows from the fuel tank 3 to the delivery pipe 6, some of the fuel that flows outside of the fuel passage 213 passes through the fuel passage 222 as shown by the arrow F2 in FIG. 2. That is, in the fuel property sensor 1, fuel flows inside the first pipe 51 towards the second pipe 52 via the fuel passage 213 or the fuel passage 222.

The thermistor 41 is a resistor body in which electrical resistance changes depending on ambient temperatures. The thermistor 41 is covered with a covering portion 42 made of resin and held in a holding space 313 that is defined by the temperature detecting part holder 31. A couple of conductive wires 13 couples the thermistor 41 and the concentration calculator 11.

The temperature detecting part holder 31 is a bottomed-cylindrical metallic member that has a bottom portion 311 and a cylinder portion 312, in which the bottom portion 311 is at a first end side of the cylinder portion 312. The temperature detecting part holder 31 is disposed in the through-hole 223. For example, the temperature detecting part holder 31 may be inserted to the through-hole 223 from the bottom portion 311. By brazing the temperature detecting part holder 31 to the through-hole 223, such that the internal electrode 22a holds the temperature detecting part holder 31, the temperature detecting part holder 31 and the internal electrode 22a are electrically coupled to be conductive.

The bottom portion 311 is closest to the central axis from among all the parts of the temperature detecting part holder 31. An inner bottom wall 317 of the bottom portion 311 abuts with the covering portion 42 (FIG. 2).

The cylinder portion 312 is generally perpendicular to the central axis , and the cylinder portion 312 and the bottom portion 311 are integrated to define the holding space 313. The cylinder portion 312 has an opening on an opposite side of the bottom portion 311. The concentration calculator 11 is coupled to an end part 316 of the cylinder portion 312, which is adjacent to the opening, by a conductive wire 122. The conductive wires 13 couple the concentration calculator 11 and the thermistor 41 via the opening of the cylinder portion 312.

A fuel seal 25 (i.e., a sealing portion) is disposed between the cylinder portion 312 and the cylinder portion 212 of the external electrode 21. The fuel seal 25 is an annular resin body that is disposed in the transfer passage 214, which is defined between the outer wall 315 of the cylinder portion 312 and an inner wall 215. The fuel seal 25 prevents fuel, which flows in the fuel property sensor 1, from leaking outside through the transfer passage 214, and isolates the external electrode 21 from the internal electrode 22a.

An annular secondary fuel passage 15 is located on the central axis side of the fuel seal 25 is defined by a first end part 251 of the fuel seal 25, the outer wall 315 of the cylinder portion 312, and the inner wall 215. That is, a part of the transfer passage 214 defines the annular secondary fuel passage 15. The annular secondary fuel passage 15 communicates with the fuel passage 213, and some of the fuel that flows in the fuel passage 213 is retained in the annular secondary fuel passage 15.

Gaps between the covering portion 42 of the thermistor 41 and the inner bottom wall 317 of the bottom portion 311, and between the covering portion 42 of the thermistor 41 and an inner wall 314 of the cylinder portion 312 (i.e., an inner wall of the holder portion) are filled with a thermally-conductive material 32. The thermally-conductive material 32 fixes the thermistor 41 in the temperature detecting part holder 31 and transfers heat from the bottom portion 311 and the cylinder portion 312 to the thermistor 41.

The concentration calculator 11 is a computer that has a central processing unit (CPU) (i.e., an operation unit), a read-only memory (ROM) (i.e., a memory unit) and a random access memory (RAM) (i.e., a memory unit). Based on charge quantities of the external electrode 21 and the internal electrode 22a, a current signal is fed to the concentration calculator 11 via the conductive wires 121 and 122. A voltage signal is fed to the concentration calculator 11 via the conductive wires 13 based on an electrical resistance of the thermistor 41.

In the fuel property sensor 1, a capacitance of a capacitor changes based on electrical characteristics of the fuel that flows in the fuel passage 213 between the external electrode 21 and the internal electrode 22a (shown by the arrow Fl in FIG. 2). The capacitor is defined by the external electrode 21 and the internal electrode 22a, through which the fuel passes. Based on the current signal provided to the concentration calculator 11 via the conductive wires 121 and 122, the concentration calculator 11 determines the capacitance. In addition, based on the voltage signal that is fed to the concentration calculator 11 via the conductive wires 13, the concentration calculator 11 also determines a temperature of the area where the thermistor 41 is located. Based on the determined capacitance and the determined temperature, the concentration calculator 11 calculates an ethanol concentration of the fuel. Information regarding the calculated ethanol concentration of the fuel is provided to the ECU 8.

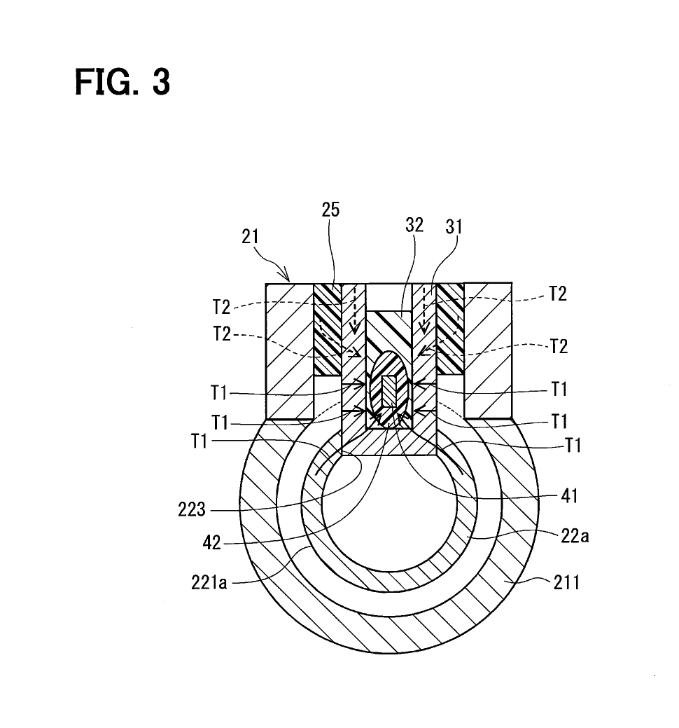

By disposing the temperature detecting part 30 in the through-hole 223, the thermistor 41 is positioned near the fuel flowing the fuel passages 213 and 222. FIG. 3 shows heat transferring to the thermistor 41 via the temperature detecting part holder 31. Solid arrows T1 show heat transfer from the fuel, and dashed arrows T2 show heat transfer from the external environment. By disposing the temperature detecting part holder 31 in the through-hole 223, heat may transfer easily from the fuel to the thermistor 41, and may have a larger effect on the temperature detected by the thermistor 41 than a case where the temperature detecting part holder 31 is disposed on the internal electrode 22a. Therefore, a detection error of the temperature detected by the thermistor 41 may be reduced, and the fuel temperature is accurately detected.

### Second Embodiment

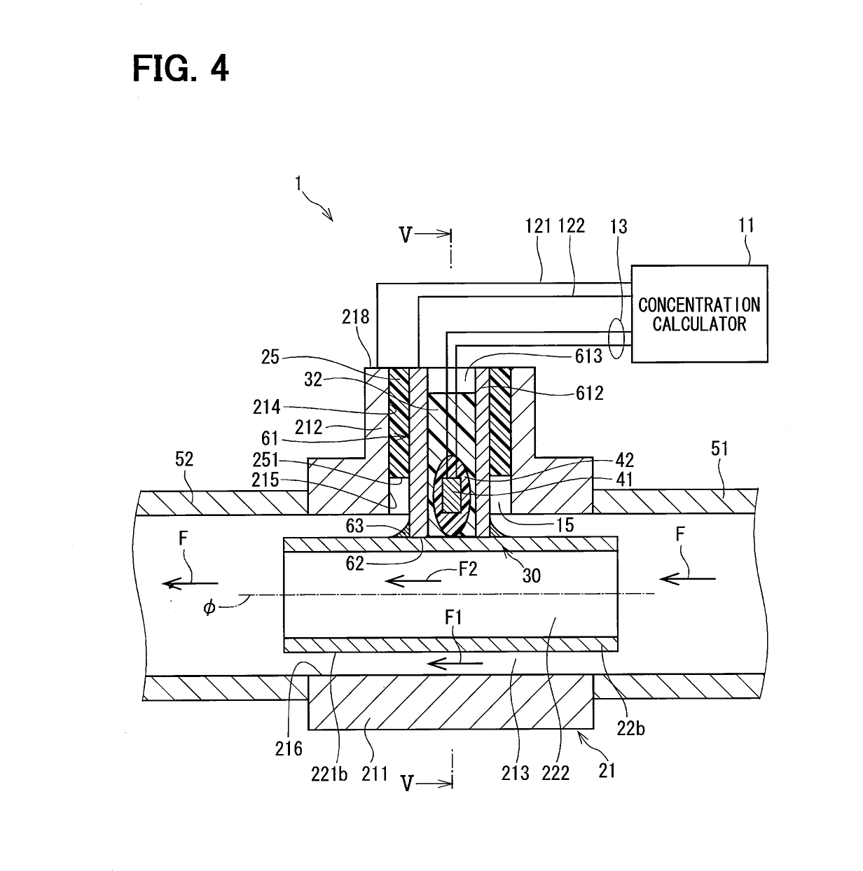

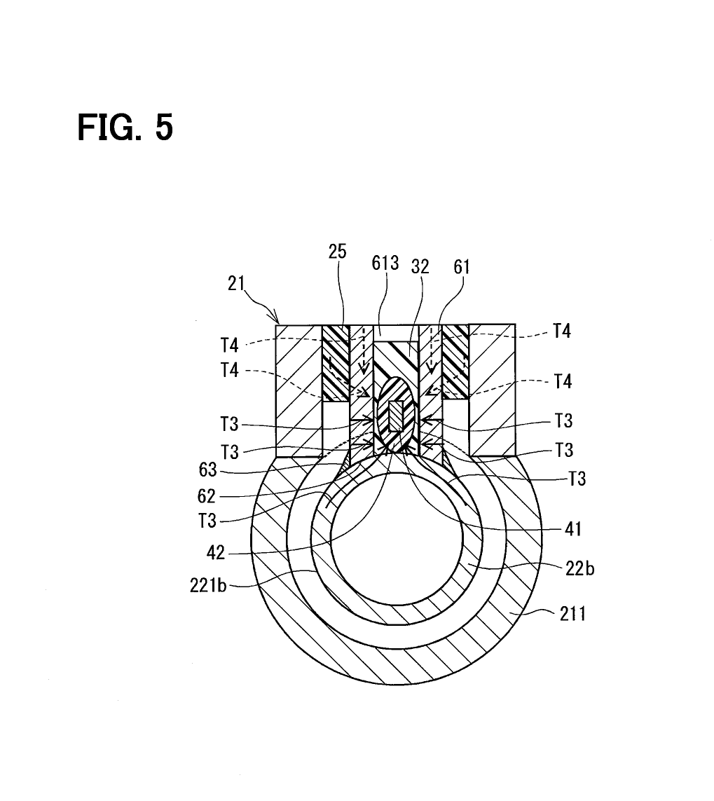

A second embodiment will be described with reference to FIGS. 4 and 5.

In the second embodiment, instead of the temperature detecting part holder 31, a fuel property sensor 2 employs a temperature detecting part holder 61 (i.e. a second holder portion) that is a cylindrical metallic member having an opening on both ends. The temperature detecting part holder 61 is disposed in the transfer passage 214. An end part 62 (i.e., a first end part of the temperature detecting part holder 61) abuts with an outer wall 221b of an internal electrode 22b, such that the temperature detecting part holder 61 and the internal electrode 22b are coupled to be conductive. A juncture line between the end part 62 and outside of the outer wall 221b is connected by a brazing metal 63 in a radial-outward direction of the temperature detecting part holder 61 (FIG. 4). The brazing metal 63 seals between the fuel passage 213 and a holder space 613 defined by an inner wall 612 of the temperature detecting part holder 61 and the outer wall 221b. In other words, the brazing metal 63 keeps liquid tightness between the fuel passage 213 and inside of the temperature detecting part holder 61.

The covering portion 42 abuts with the outer wall 221b.

The thermistor 41 abuts with the outer wall 221b via the covering portion 42. FIG. 5 shows heat transferring to the thermistor 41. Solid arrows T3 show heat transfer from the fuel, and dashed arrows T4 show heat transfer from the external environment. By disposing the covering portion 42 to abut with the outer wall 221b, the thermistor 41 is positioned near the fuel flowing in the fuel passages 213 and 222, and heat transfers from the fuel to the thermistor 41 via both the temperature detecting part holder 61 and the internal electrode 22b. By passing the fuel through the internal electrode 22b, the internal electrode 22b is heated to the same temperature as the fuel. Therefore, heat transfers easily from the fuel to the thermistor 41 and may have a larger effect on the temperature detected by the thermistor 41 than a case where a temperature detecting part holder having a bottomed-cylindrical shape such as the temperature detecting part holder 31 is employed. Thus, the fuel property sensor 2 in the second embodiment may have performance comparable to the fuel property sensor 1 in the first embodiment.

### Other Embodiments

Although the temperature detecting part holder 31 is connected to the internal electrode 22a by brazing in the first embodiment, the temperature detecting part holder 31 can be connected to the internal electrode 22a by welding, abutment, or the like.

Although the temperature detecting part holder 61 and the internal electrode 22b are connected by brazing to keep the liquid tightness between the fuel passage 213 and the holder space 613 in the second embodiment, the temperature detecting part holder 61 and the internal electrode 22b can be connected by welding to keep the liquid tightness.

Although the fuel temperature is detected by the thermistor 41 in the first and the second embodiments, a device that detects the fuel temperature is not limited to this application, and, for example, a thermocouple may be applicable.

Such changes and modifications are to be understood as being within the scope of the present disclosure as defined by the appended claims.

What is claimed is:

1. A fuel property sensor comprising:
an external electrode including a passage portion, which defines a fuel passage, and a projecting portion, wherein the passage portion and the projecting portion define a transfer passage, in which fuel flows therethrough, and the projecting portion radially projects from the passage portion;
an internal electrode disposed in the passage portion of the external electrode at a predetermined distance from an inner wall of the passage portion, the internal electrode defining a through-hole;
a temperature detecting device which detects a fuel temperature;
a holder portion having a cylinder portion and a bottom portion, which define a bottomed-cylindrical holding space, in which the temperature detecting device is disposed;
a sealing portion disposed between an outer wall of the holder portion and an inner wall of the transfer passage, wherein the sealing portion insulates the external electrode and the holder portion from each other, and prevents fuel flowing in the transfer passage from leaking outside; and
a calculation unit which calculates fuel properties based on the fuel temperature detected by the temperature detecting device and calculating electrical characteristics of fuel flowing between the external electrode and the internal electrode.

2. The fuel property sensor according to claim 1, wherein
the holder portion is disposed in the transfer passage and the through-hole, such that the holder portion abuts with the internal electrode and is electrically coupled with the internal electrode.

3. A fuel property sensor comprising:
an external electrode including a passage portion, which defines a fuel passage, and a projecting portion, wherein the passage portion and the projecting portion define a transfer passage, in which fuel flows therethrough, and the projecting portion radially projects from the passage portion;
an internal electrode disposed in the passage portion of the external electrode at a predetermined distance from the inner wall of the passage portion;
a temperature detecting device which detects a fuel temperature;
a holder portion having a cylindrical shape with an opening provided at both ends and holding the temperature detecting device therein;
a sealing portion disposed between an outer wall of the holder portion and an inner wall of the transfer passage, wherein the sealing portion insulates the external electrode and the holder portion from each other, and prevents fuel flowing in the transfer passage from leaking outside; and
a calculation unit which calculates fuel properties based on the fuel temperature detected by the temperature detecting device and calculating electrical characteristics of fuel flowing between the external electrode and the internal electrode.

4. The fuel property sensor according to claim 3, wherein
the holder portion is disposed in the transfer passage, wherein a one end part of the holder portion is connected to an outer wall of the internal electrode, such that a gap between the fuel passage and inside of the holder portion is sealed to prevent fuel leakage, and the holder potion and the internal electrode are electrically coupled.

5. The fuel property sensor according to claim 3, wherein
the one end part of the holder portion and the outer wall of the internal electrode are connected by brazing.
